(19) United States
(12) Patent Application Publication
(10) Pub. No.: US 2017/0158432 A1
(43) Pub. Date: Jun. 8, 2017

(54) WATER COLLECTION SYSTEM

(71) Applicant: Geo Products, LLC, Houston, TX (US)

(72) Inventor: Jeffrey R. Pearce, Andover, KS (US)

(73) Assignee: Geo Products LLC, Houston, TX (US)

(21) Appl. No.: 15/339,154

(22) Filed: Oct. 31, 2016

Related U.S. Application Data
(60) Provisional application No. 62/264,064, filed on Dec. 7, 2015.

(51) Int. Cl. B65G 5/00; E03B 3/06; E02B 11/00

(52) U.S. Cl. CPC B65G 5/005; E02B 11/00; E03B 3/06; E03B 3/02

(57) ABSTRACT

A water collection system at least partially below ground level comprises a water collection structure comprising at least one layer of hydraulically interconnected cells extending two dimensionally, and disposed substantially parallel to ground level, the grid the structure having a peripheral edge and particulate solid material in at least some of the cells providing a void space of from about 30% to about 70% in at least some of the cells. There is a water inlet into the structure, a substantially water impermeable layer below substantially all of the water collection structure, a water discharger from the structure, and a protective layer of material above the water collection structure.

### CROSS REFERENCE

This application claims the benefit of priority from U.S. provisional patent application Ser. No. 62/264,064 filed Dec. 7, 2015.

### BACKGROUND

There is a need for maximizing usage of precipitation, such as by replenishing aquifers and collecting precipitation for usage rather than losing it to run-off.

### SUMMARY

The present invention is directed to a water collection system that satisfied this need. In a preferred first version of the invention the system comprises a water collection structure comprising at least one layer of multiple cells extending two dimensionally, the cells being hydraulically interconnected and the layer, also referred to as a cellular grid, disposed substantially parallel to ground level. For increased water collection, preferably there are multiple layers of cells. The water collection structure has a peripheral edge. Particulate solid material is in at least some of the cells providing a void space of from about 30% to about 70% in at least some of the cells. (All void spaces are by volume as measured by ASTM test C29.) A water inlet is provided into the structure. The water can enter the structure from above the structure, from a pipe extending laterally into the structure or from both. A substantially water impermeable layer such as a polymeric liner is below substantially all of the water collection structure and along at least a portion of the peripheral edge of the structure for retaining water in the structure. There is a water discharger, such as a sump pump, for removing retained water. Instead of or in addition to a pump, the water discharger can be a water removal line proximate to the bottom of the water collection structure. There is a protective layer of material above the structure. Optionally the particulate solid material is only above the structure.

An alternative to this first water collection system is instead of using a water collection structure of cellular layers, a geosynthetic reinforcement is used with the particulate solid material above the geosynthetic reinforcement.

The protective layer can be impermeable, such as concrete or asphalt. With such material, preferably between the water collection structure and the protective layer is a bond breaker for preventing the cellular pattern from showing on the surface of the impermeable layer. Exemplary of impermeable layers that the invention can be used for are a parking lot, sidewalk, playground, roadway or athletic court,

Where the protective layer is impermeable, the water inlet can be a water drain. In addition to or instead of a drain, there can be permeable material that serves as a water inlet. This can be a parking lot island or a green soil area.

Alternatively, the protective layer can be at least partially water permeable, such as landscaping, and serve as the water inlet.

Preferred particulate solid material is stone number 57.

This can include an overflow pipe and/or an inspection port and/or maintenance port.

Preferred optionally there can be non-woven material below the substantially permeable layer and/or between the substantially impermeable layer and water collection structure.

The invention also includes a method for collecting run-off water using the system wherein a hole is excavated below ground level and there is placed in the hole sequentially the substantially water impermeable layer, the cellular layer(s), and the particulate solid material. Then the protective layer is placed above the water collection structure.

### DRAWINGS

These and other features, aspects, and advantages of the present invention will become better understood with regard to the features listed below, the following description and, accompanying drawings where:

FIG. 1 is a schematic view of the system according to the present invention being used below an impermeable pavement with an area inlet provided with a slotted grate;

FIG. 2 is a schematic view of a second system according to the present invention using a dry well with a slotted grate as the water inlet;

FIG. 3 is a schematic view of a third version of the present invention useful for a parking lot having a parking lot island;

FIG. 4 is a schematic view of a fourth version of the present invention wherein an impermeable surface is provided with permeable pavers as the water inlet;

FIG. 5 is a schematic view of a fifth version of the present invention wherein a portion of the area above the water collection structure comprises a water permeable green belt; and

FIG. 6 is a schematic view of a sixth version of the present invention using a geosynthetic material instead of a cellular layer;

### DESCRIPTION

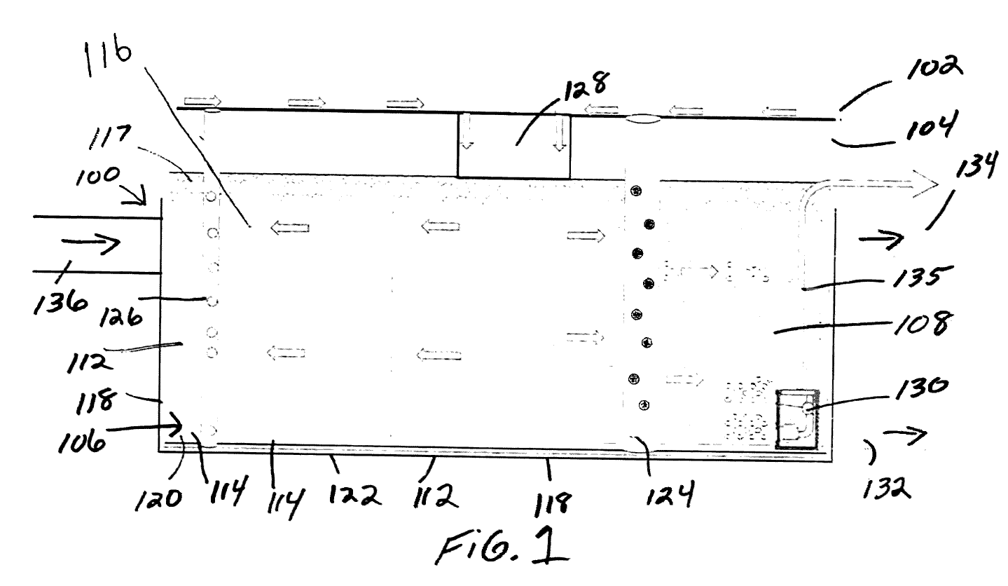

With regard to FIG. 1 a system 100 of the present invention has starting, at ground level 102, a substantially water impermeable surface 104 comprising a material such as concrete or asphalt. The surface 104 can be one of many impermeable surfaces, such as a parking lot, foundation, roadway, or a playground surface such as a basketball court.

Below the impermeable layer is a water collection structure 106 comprising at least one, and as shown in FIG. 1, three dimensional layers of multiple cells 108 extending laterally, the cells being hydraulically interconnected and the layer(s) being disposed substantially parallel to ground level 102. The structure 106 has a peripheral edge 112 and a bottom edge 114. Each layer has from about 100 to about 400 cells. By “hydraulically interconnected” there is meant that water in once cell can flow into another cell, such that all of the cells of a cellular layer can be filled with water. However it is possible that some cells are hydraulically isolated from all other cells, either intentionally or as a result of a manufacturing defect.

A preferred layer of cells, also referred to as a cellular grid, is available from Geo Products, LLC of Houston, Tex. under the trademark Envirogrid. The cells of an Envirogrid cellular grid can be from about 3 to about 12 inches in depth, have a nominal expanded cell size of about 10 to about 20 inches wide and about 8 to about 19 inches long, and a nominal expanded cell area of about 45 to about 185 square inches. Envirogrid cellular grids are about 5 to about 10 cells wide, about 29 cells long, have a nominal expanded section about 8 feet to about 65 feet, and a nominal expanded section area of about 180 to about 520 square feet. They are made of high density polyethylene having a polymer density according to ASTM 1505 of about 58.4 to about 60.2 pounds per cubic foot. The cellular grid can be made from cellular material provided by other manufacturers and the invention is not limited to those provided by Geo Products.

The arrows in the Figures show the direction of water flow, and the clouds represent rain clouds dropping rain. The system can also be used to collect water from other sources, such as air conditioning condensation.

Multiple cellular grids can be placed laterally, either spaced apart or side-by-side. Side-by-side cellular grids can be hydraulically interconnected or can be hydraulically separated.

Particulate solid material 116 is in at least some of the cells 108, and preferably all of the cells. To provide a good balance between support for the overlying pavement surface 104 and an ability to capture water, the particulate material provides a void space from about 30% to about 70% in at least some of the cells, and preferably from about 30% to about 40%. A suitable particulate solid material is stone number 57. Other clean fills with the appropriate void space can be used as the particulate solid material 116, such as sand and clean rock. Also glass, and ceramics can be used. Ceramics can be obtained from discarded or rejected toilets and bath tubs.

In addition, recycled tires can be used, such as tire derived aggregate or tire derived fuel. Tire derived aggregate (TDA) comprises scrap tires cut into pieces. Typically, TDA has a basic geometrical shape and range between 2 inches (50 mm) and 3 inches (75 mm) in particle size as measured with a mesh. Tire derived fuel (TDF) likewise comprises scrap tires cut into fuel, with substantially all steel reinforcement removed, and generally without any other fuel added. Generally, the TDF or TDA has a maximum size of about 3 inches. Recycled tires are particularly useful where structural support for the overlying surface, such as a greenbelt surface, is not needed.

Preferably there is a protective layer 117 of material above the structure 106 and below the pavement 104. Preferably the protective layer 117 is at least 2 inches thick, and can be made of the infill material being used for the installation.

Below the structure 106 along its bottom edge 114 is a water impermeable layer, preferably water impermeable liner 118, which extends to the peripheral edge 112 and along the peripheral edge 112 of the structure, and preferably along the entire peripheral edge 112 of the structure for retaining trapped in water in the structure 106. The liner 118 can be made of polyethylene, polyester, or polypropylene, or other suitable substantially impermeable liner material. The liner 118 can be separated from or in contact with the structure 106. The liner 114 is typically about 8 to about 80 mils thick.

Optionally above the liner is an internal layer 120 of fabric and also optionally below the liner is an external layer 122 of fabric. The internal layer 120 can be substantially coextensive with the bottom edge 114 of the structure 106. The external layer 122 can be substantially coextensive with the bottom edge 114 of the structure 106, and can also extend along the peripheral edge 112 of the structure 106. Preferably the fabric is a geotextile fabric typically made of polypropylene or polyester, and which provides reinforcement and protection for the liner 118. The fabric layers 120 and 122 are preferably formed of polyester or polypropylene and are about 4 to about 24 ounces per square yard.

Optionally a maintenance port 124 extending vertically through the structure, cover material, and impermeable pavement is provided, the maintenance port 124 being apertured. It can be used for injection of water for flushing out accumulated particulates blocking the voids. Preferably the maintenance port comprises two pipes approximately 6 to about 12 inches in diameter with weep holes of about ¼ to about ¾ inch, and preferably about ½ inch in diameter. One is preferably placed on either side of the system. One is used for flushing out captured debris and the other can be used for vacuuming out the captured debris. The installed length is preferably from the lowest elevation of the structure 106 to the finish grade with the weep holes only continuing to below the impermeable pavement. The total void space provided by the weep holes in the surface of the maintenance port pipe is about equal to the void space of the particulate material. Thus if the particulate material has a void space of 50%, then the weep holes comprise about 50% of the surface area of the maintenance port.

Optionally an inspection port 126 is provided, the inspection port comprising a vertically oriented tubular structure with apertures, so that it can be determined when flushing is needed. An inspection port typically has a diameter of about 6 to 8 inches, with weep holes that are approximately ¼ inch diameter for visual inspection. The total void space provided by the weep holes and the inspection port is about equal to the void space of the particulate material. Preferably the inspection port is installed with a length from the lowest elevation of the system to the finished grade with the weep holes existing only to the highest elevation of the structure.

As is typical with pavement structures, there is provided an area inlet 128 for water drainage from the impermeable pavement 104 downwardly into the water collection system 100. The area inlet 128 is a place or means of entry generally made from a metal seat with a slotted metal grate. Water run off enters the area inlet and seeps into the system 100.

Water collected in the system 100 can be pumped out with a pump 130, such as a sump pump, located at the bottom of the structure 106. The pump 130 can pump collected water upwardly through line 135 for lateral discharge at an elevation above the structure 106. In addition, or optionally, a water outlet pipe 132 can be used near the bottom of the structure 106 for controlled release of water. A typical diameter for such pipe is from about 8 to about 48 inches. It is sized to release the captured run off at a controlled rate. The water outlet pipe 132 extends outwardly from the structure 106.

To avoid over collection of water, and can adversely affect the impermeable pavement surface 104, preferably there is an overflow pipe 134 placed towards the top of the structure and extending laterally out of the structure 106. A typical diameter for such pipe is from about 8 to about 48 inches.

An optional inlet pipe 136 is provided extending laterally into an upper portion of the structure 106. This can be used instead of or in addition to the area inlet 128. The lateral inlet pipe 136 can be used for capturing water from adjacent empty or permeable area such as a pond or marshy area. A typical diameter for such an inlet pipe is from about 8 to about 48 inches.

To install the system 100, a hole is excavated below ground level and then the components of the system are sequentially placed in the excavated hole, typically in the order of the substantially water impermeable liner 118, the structure 106, the particulate solid material 116, the protective layer and then the permeable pavement.

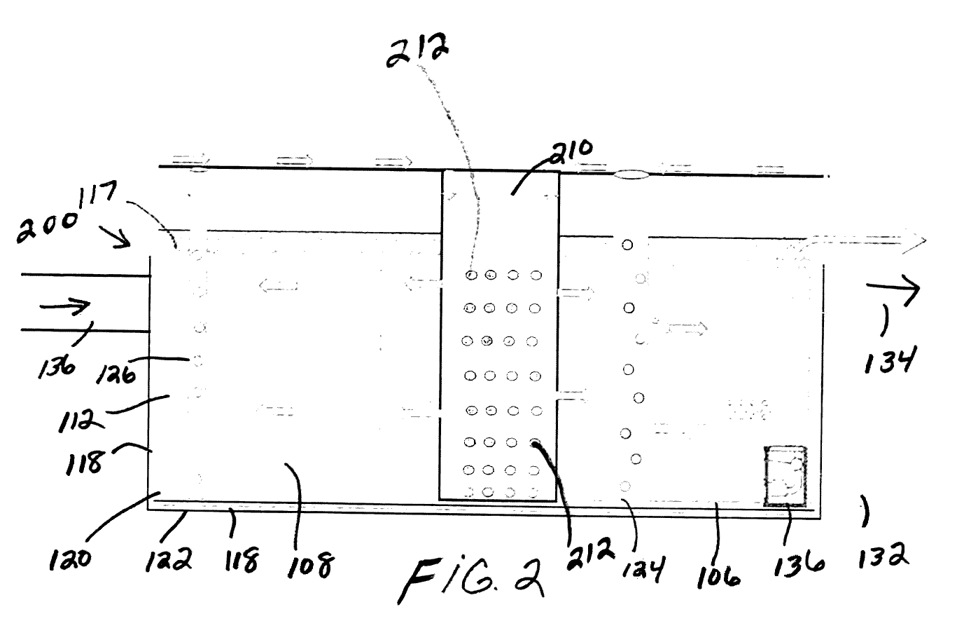

FIG. 2 shows a version of the invention where instead of the area inlet 128, there is used a dry well 210 for the water inlet. A dry well shaft or chamber is constructed from cast in place concrete, plastic pipe or other rigid material in the ground to aid drainage. Run off enters the dry well through a metal or plastic grate at the surface and fills the dry well which then seeps into the system 200 laterally through holes 212 placed in the dry well material. The dry well 210 can be empty or filled with rock, sand, or other filtering material.

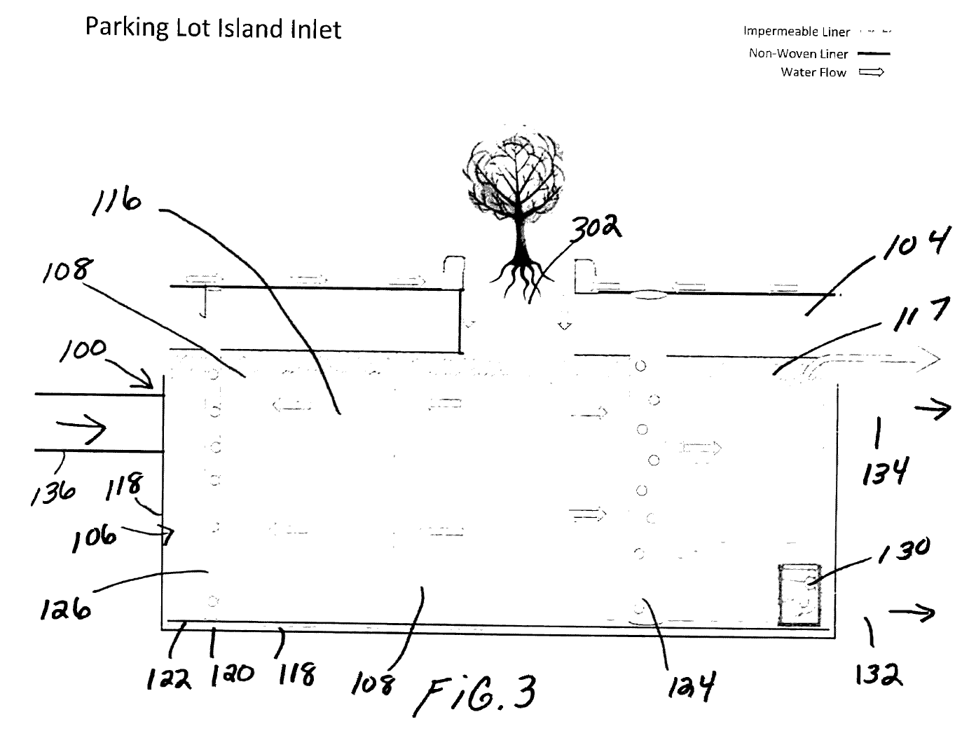

FIG. 3 shows a system 100 similar to that of FIGS. 1 and 2, where instead of an area inlet or a dry well, a parking lot island 302 or other planted area is used for the water inlet. The parking lot island 302 is a curbed area in a parking lot used to delineate traffic and is general filled with vegetation and mulch or rock or bioswale constructed of native grasses and wild flowers or specially modified soils. Run off enters the island through a curb opening and drains into the system 100.

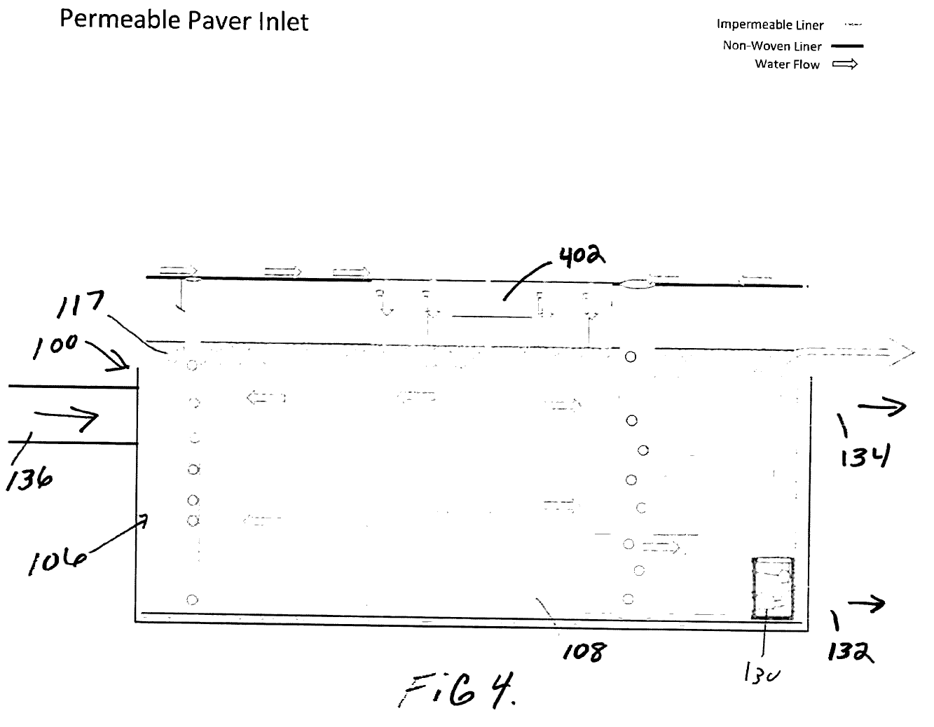

FIG. 4 shows a system 100 similar to that of FIGS. 1-3 where permeable pavers 402 are used as the water inlet. Permeable pavers are permeable blocks placed side-by-side or an articulating block mat with water run off capabilities. Example of materials used can be pervious concrete, porous asphalt, paving stones, or concrete or plastic based pavers.

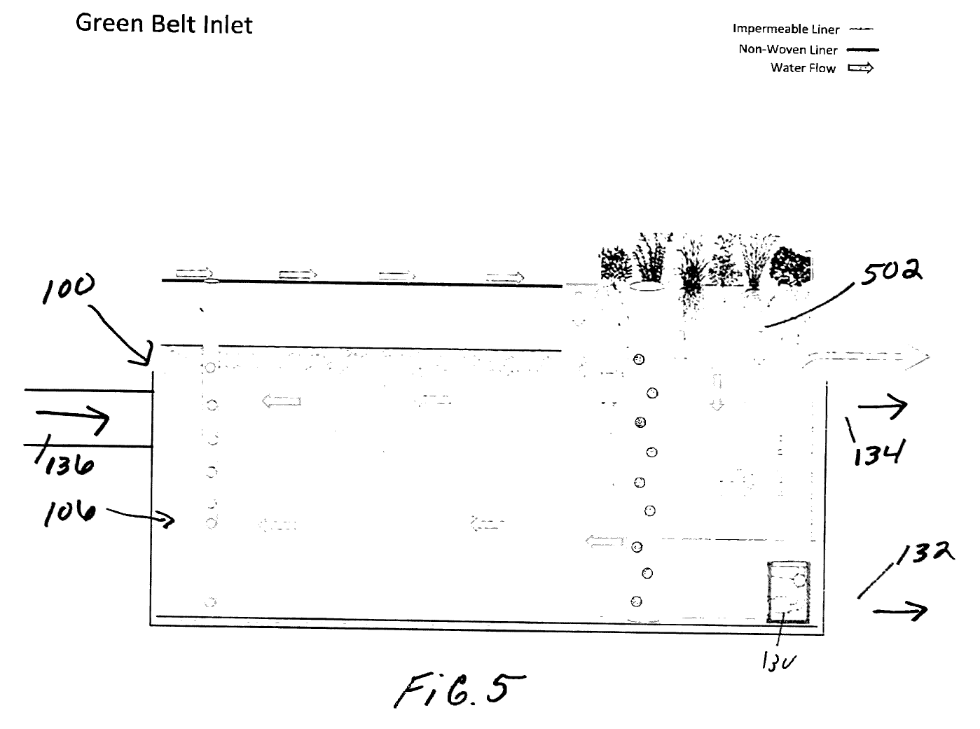

A system according to the present invention can be used below a partially or totally permeable layer, referred to as a protective layer. For example, with regard to FIG. 5, there is shown a system 100 where adjacent to the impermeable material 104 there is such as a green belt area 502. A green belt area is a vegetated area located in places such as next to a street, a median between lanes of traffic, or an area adjacent to a parking lot, often with curbing to delineate traffic. Also the system can be used below an impermeable layer, such as a parking lot or highway, if it is possible to get water into the system such as through a lateral pipe inlet or drain. The impermeable layer can be made of concrete or asphalt, for example.

The green belt area can be referred to as a bioswale constructed of native grasses and wild flowers or specially modified soils. Water can enter the structure 106 by seeping through the green belt area and/or through a curb opening and drains into the cellular grids. In all versions of the invention, when a green belt is used to allow water into the collection system, an advantage of having a portion or all of the water flow through a green belt into the system is the water is naturally filtered.

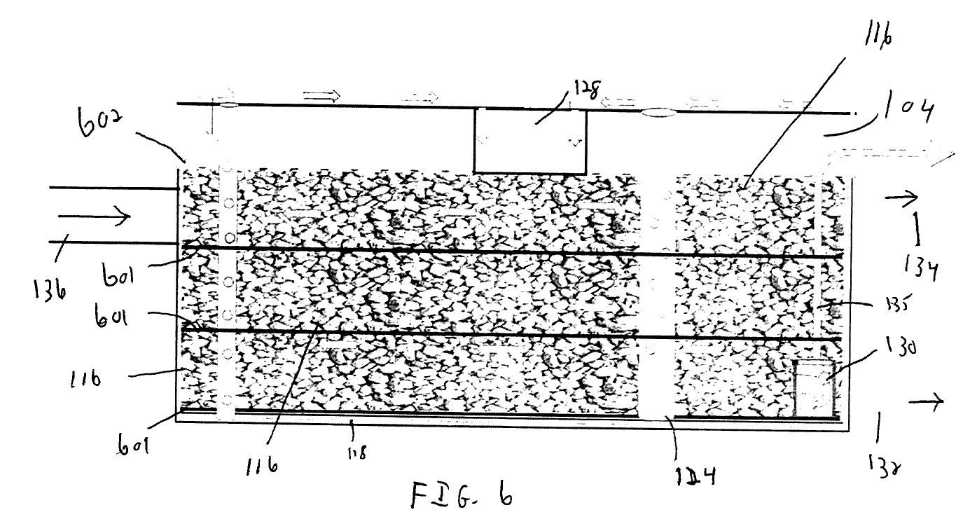

As shown in FIG. 6, in another version of the invention, instead of using a cellular grid structure, one or more than one layer of geosynthetic material 601 can be used. Different geosynthetic materials can be used, such as woven or non-woven geotextiles or geo geogrids. A common definition of geotextiles is any permeable textile used with foundation soil, rock, earth, or other geo technical engineering-related material as an integral part of a human-made project structures system. In the version of FIG. 6 there are three layers of geosynthetic material. The layers can be vertically spaced apart, substantially parallel to each other and ground level, and extend substantially horizontally. Each layer supports a layer of particulate material 116, which is substantially thicker than the layers of geosynthetic material.

In all versions of the invention, the system optionally can have peripheral supports for supporting at least a portion of peripheral edge of the water collection structure. Preferably the supports are of the same structure as the cellular grid, and thus comprise a layer of multiple cells extending two dimensionally, the cells being hydraulically interconnected, and the layer being disposed substantially vertical to ground level. The peripheral supports can have the cells contain structural support materials such as used in the water collection structure cells.

Systems according to the present invention have multiple advantages. They can capture and save water that is ordinarily run off into rivers or lakes, allowing use of the water such as for irrigation, or after treatment as potable water. In addition, the structure provides support for any overlying surface.

Other versions of the invention are possible. For example, in all versions of the invention a bond breaker 602 can be used between the structure 106 and the protective layer, as shown in FIG. 6. The bond breaker 602 prevents the cellular pattern from showing on the surface of the impermeable layer 104. A bond breaker is a layer of separator substance applied in different forms between adjoining solid surfaces. It is used to ensure that there is no adhesive molecular bond between the surfaces. A suitable bond breaker is available from Tencate Geosynthetics Americas under the trademark Mirafi.

Thus the claims should not be limited to the preferred versions described herein.

What is claimed is:

1. A water collection system at least partially below ground level comprising:
a) a water collection structure comprising at least one layer of multiple cells extending two dimensionally, hydraulically interconnected, and disposed substantially parallel to ground level, the water collection structure having a peripheral edge;
b) particulate solid material in at least some of the cells providing a void space of from about 30% to about 70% in at least some of the cells;
c) a water inlet into the water collection structure, the water inlet being from (i) above the structure, (ii) a pipe laterally into the water collection structure, or both (i) and (ii);
d) a substantially water impermeable layer below substantially all of the water collection structure and along at least a portion of the peripheral edge for collection of water in the water collection structure;
e) a water discharger from the water collection structure; and
f) a protective layer of material above the water collection structure.

2. The system of claim 1 comprising non-woven material between the substantially impermeable layer and the water collection structure.

3. The system of claim 1 wherein the water discharger is a water flow line proximate to the bottom of the grid.

4. The system of claim 1 wherein the water collection structure comprises multiple layers of cells.

5. The system of claim 1 wherein the void space is from about 30% to about 40%.

6. The system of claim 1 wherein the protective layer comprises concrete or asphalt.

7. The system of claim 1 where between the water collection structure and the protective layer is a bond breaker for preventing the cellular pattern from showing on the surface of the impermeable layer.

8. The system of claim 1 wherein the protective layer is at least partially water permeable and serves as the water inlet.

9. The system of claim 1 wherein the protective layer is impermeable and the water inlet is a drain for the impermeable layer.

10. The system of claim 1 wherein the impermeable layer is a parking lot, side walk, playground, roadway, or athletic court, and the water inlet is drain openings.

11. The system of claim 1 comprising an overflow pipe.

12. The system of claim 1 wherein the particulate solid material is stone number 57.

13. The system of claim 1 comprising fabric below the impermeable layer.

14. The system of claim 1 comprising non-woven material below the substantially impermeable layer.

15. A method for collecting run off water using the system of claim 1 comprising the steps of:
a) excavating a hole below ground level;
b) placing in the hole sequentially the substantially water impermeable layer, the water collection structure, and the particulate solid material below ground level; and
c) placing the protective layer above the water collection structure.

16. A water collection system at least partially below ground level comprising:
a) a water collection structure comprising at least one layer of multiple cells extending two dimensionally, the cells being hydraulically interconnected, and the water collection structure being disposed substantially parallel to ground level, the water collection structure having a peripheral edge;
b) particulate solid material on at least a portion of the cells providing a void space of from about 30% to about 70%;
c) a water inlet into the water collection structure, the water inlet being from (i) above the water collection structure, (ii) a pipe laterally into the water collection structure, or both (i) and (ii);
d) a substantially water impermeable layer below substantially all of the water collection structure and along at least a portion of the peripheral edge of the water collection structure for collection of water in the water collection structure;
e) a water discharger from the water collection structure; and
f) a protective layer of material above the water collection structure.

17. A water collection system at least partially below ground level comprising:
a) at least one layer of geosynthetic reinforcement extending two dimensionally and disposed substantially parallel to ground level, the grid having a peripheral edge;
b) particulate solid material on at least a portion of the geosynthetic reinforcement providing a void space of from about 30% to about 70%;
c) a water inlet to the particulate solid material, the water inlet being from (i) above the particulate solid material, (ii) a pipe extending laterally into the particulate solid material, or both (i) and (ii);
d) a substantially water impermeable layer below substantially all of the geosynthetic reinforcement and along at least a portion of the peripheral edge of the particulate solid material for collection of water; and
e) a water discharger from the particulate solid material

18. The system of claim 1 wherein the particulate solid material comprises recycled tires.

19. The system of claim 1 comprising supports for at least a portion of peripheral edge of the water collection structure, the supports comprising layer of multiple cells extending two dimensionally, the cells being hydraulically interconnected, and the cells being disposed substantially vertical to ground level.

20. A water collection system substantially below ground level comprising:
a) a water collection chamber having a peripheral edge;
b) water permeable ground above the chamber wherein water can flow into the chamber through the water permeable ground for collecting of water in the water collection chamber thereby filtering the water;
c) a substantially water impermeable layer below substantially all of the chamber and along at least a portion of the peripheral edge for collection of water in the chamber; and
d) a water discharger from the grid.
